(19) United States
(12) Patent Application Publication
(10) Pub. No.: US 2002/0107134 A1
(43) Pub. Date: Aug. 8, 2002

(54) Method for producing ceramic fibers, the fibers thus produced and their use

(76) Inventor: Klaus Rennebeck, Wendlingen (DE)

Correspondence Address: Scott A. McCollister, Fay, Sharpe, Fagan, Minnich & McKee, LLP, Seventh Floor, 1100 Superior Avenue, Cleveland, OH, 44114-2518, US

(21) Appl. No.: 10/108,327

(22) Filed: Mar. 28, 2002

Related U.S. Application Data
(63) Continuation of application No. 09/463,050, filed on Apr. 25, 2000.

(30) Foreign Application Priority Data
Jul. 18, 1997 (DE) 197 30 996.8

(51) Int. Cl. C04B 35/00

(52) U.S. Cl. 501/95.1

(57) ABSTRACT

The invention relates to a method for producing ceramic fibers from a molten mass. In accordance with this method, a molten mass of ceramic starting materials, at a temperature of at least approx. 1150° C., is passed through the nozzle of a tool, and then left to solidify. At least the parts of the tool which are subjected to the effect of the molten mass are made of a material having a melting point of over approximately 2200° C., as well as the necessary consistency and corrosion resistance. The invention also relates to the ceramic fibers produced by this method, in particular hollow microfibers, preferably in monolithic form, and their use.

The invention concerns a method for the manufacture of ceramic fibers from the liquefied material, the therefrom obtainable ceramic fibers, particularly in the shape of micro hollow fibers, as well as utilization of said ceramic fibers.

The older international application PCT/EP97/00255 concerns micro hollow fibers from ceramic materials. These are suitable for a multitude of beneficial applications, for example the manufacture of membranes, molecular sieves, catalyst carriers, filters and similar. The older application gives a detailed description of how these micro fibers are produced. In this context, a spinning process is pointed out as a particularly preferred method. In accordance with said method, the dispersion, which contains the precursers of the ceramic material, for example in the form of clay minerals, metal hydroxides, mixed metal hydroxides/-oxides, mixed metal oxides/metalhalogenides, metal-oxides, metal-nitrides, metal-alcoholates, feldspars, zeolites or beomites and a thermally removable binder, for example carbonyl-diamide, polyvinylalcohol, polymerthermoplastic starch (PTS), wax, agar, proteins or saccarides, is placed in to a charging vessel or pressure vessel of the spinning device. The dispersion is passed through the spinning device at a temperature of approximately 20 to 400° C. and pressed through nozzles. The flows generated in the area of the nozzle aperture are centrally divided by means of cores and/or by devices for blowing in a gas. The flows are solidified to green micro-hollow-fibers by heating, radiation, or addition of a reaction partner. The obtained green micro-hollow fibers are baked into finished micro-hollow fibers.

The earlier described factual frame resulting from the older application makes clear that the method for the manufacture of the finished product in form of the ceramic micro-hollow fibers is costly by comparison, inasmuch as initially a green product and same must then be subjected to another treatment step in order to manufacture the finished product. Simplification in method handling would be of benefit.

Accordingly, it is the object of the present invention to propose a particularly easily implemented method for the manufacture of ceramic fibers, specifically hollow fibers and micro-hollow fibers.

According to the invention, said object is solved by a method for the manufacture of ceramic fibers from the liquefied material which is characterized in that liquefied material of ceramic starter substances, having a temperature of at least approximately 1150° C., is passed through a nozzle of a mold and is then permitted to solidify, whereby at least the components of the mold, which are subjected to the influence of the liquefied material, consist of a material having a melting point of more than approximately 2200° C.

The above specified minimum ceramic melt temperature of 1150° C. is as a rule greatly surpassed in the preferred starter materials in form of oxide- nitride- and/or carbide materials and preferably lies at no less than approximately 1 600° C., and more specifically preferred, at more than 1900° C. In some instances it may even be necessary to set temperatures of approximately 2200° C. in order to manufacture the required liquefied material. Consequently, the setting of the minimum temperature inevitably depends upon the melt temperatures of the starter materials. The preferred ceramic starter materials of the above mentioned type, i.e. oxide-, nitride- and/or carbide materials are aluminum-oxide, magnesium-oxide, silicone-oxide, titanium-ioxide, beryllium-oxide and/or zirconium-oxide. Aluminum-oxide is a particularly beneficial starter material, specifically in form of leucosapphire, preferably in powdery form, which has a melt temperature of approximately 2200° C.

In order to withstand the specified high temperatures of the liquefied material of the different starter materials, those parts of the mold, which are exposed to the influence of the liquefied material of the starter materials, must consist of a material which has a melting point above 2200° C., have the necessary solidity and be corrosion-resistant. Materials which are preferably employed in this instance are tantalum, tungsten, materials of the eighth sidegroup, aluminum-nitride and/or zirconium-dioxide. For production of the mold it is also possible to employ compound structures from these materials. Of critical importance is the adequately high melting point which is not attained by the liquefied materials of the starter materials. In addition, these materials demonstrate when the respective mold is put into operation that they have the required solidity properties and that they satisfy the requirements of corrosion resistance towards the different ceramic starter materials. Corrosion resistance is specifically required and/or of benefit if corroding gases are generated from the liquefied materials. This applies, for example, with respect to starter materials that release substances whose condensates form aqua regia [nitrohydrochloric acid]. General basic specifications for materials from which the mold is made must be established as follows: melting point above 2200° C., sufficient stability, i.e. (shape)-friability when executing the process and preferably resistance towards corrosion, in particular toward the mentioned acids.

For production of beneficial products, specifically in form of ceramic micro fibers, the nozzle of the mold preferably has a diameter of approximately 300 to 7 μm. By stretching the spun fiber during the high melt temperature spinning step, after exiting from the nozzle aperture, and while still in the plastic phase, there occurs a reduction in the cross-section. It is of benefit that the temperature of the liquefied material lies by approximately 250° C. above the solidification- or the melting point of the ceramic materials of the corresponding metal materials. The effect of the cross sectional reduction is particularly evident if the processing is done [at temperatures] far above the melting point proper or the solidification point proper of the ceramic starter materials. Another technical assertion might state that the temperature of the liquefied material is selected in such manner that its enthalpy lies by approximately 5 tp 40% above the temperature of the eutectic mixture of the ceramic starter materials. Thus, it is particularly beneficial to approach, as closely as possible, the melting temperature of the mold materials without detrimentally affecting same in their capacity to function. The mentioned ceramic starter materials are brought to the required temperature, prior to the process proper, for example by means of electric arc melting process or plasma melt process or similar. The thus produced liquefied material is transferred to the mold equipped with the mentioned nozzles.

The method according to the invention can, on the one hand, be fashioned so that solid ceramic fibers are created. Based on the dimension of the nozzle and by regulating the mentioned conditions in relationship to the liquefied material, it is possible to accurately adjust the desired diameters of the fibers. On the other hand, the method according to the invention permits the manufacture of hollow ceramic fibers. A co-axial lumen maker is hereby centrically arranged in the nozzle of the mold, in flow direction of the liquefied material, with said lumen maker preferably projecting beyond the edge of the nozzle. Said lumen maker may be a core or a device for blowing in a fluid, such a oxygen, nitrogen, air, preferably inert gases, or another gaseous mixture. The lumen is then formed by the lumen maker, with preferably subsequent flow of fluid from the center of the lumen maker. Based on the arrangement of the lumen maker within the nozzle, annular or profile apertures appear, whereby said apertures may be designed in such manner that the greatest possible number of nozzles, for example several thousands, are located next to each other at regular intervals in an extremely tight space. The lumen maker may, for example, be produced as follows: A cone-shaped ‘green product’ is manufactured—for example of aluminum and a thermoplastic substance—in one “thermoplastic, final contour finished” injection molding process step. Targeted hole-making is done by laser in a longitudinal direction of the cone towards the tip of the cone. After that, the thermoplastic substance is burned, so that the ceramic lumen maker is formed. If tantalum, tungsten or zirconium-dioxide is employed, then processing of these materials is to be done in the form of powder, which has been mixed with the thermoplastic substance.

With a sufficiently small nozzle, with the mentioned lumen maker, and subject to executing the rest of the process as mentioned above, it is possible to obtain a ceramic micro-hollow fiber having a wall thickness of approximately 0.01 to 15 μm and outer diameter of 0.5 to 35 μm.

A particular benefit of the method according to the invention is to be seen in that it is possible, subject to the mentioned conditions, to manufacture monolithic ceramic fibers, either as solid fibers or also as hollow fibers. The term “monolithic” implies a socalled single crystal, i.e. the molecular or crystal lattice has everywhere the same orientation in the solid ceramic fiber (see Römpps Chemical Lexicon, 8th edition, volume 2, page 1151).

The method according to the invention permits the manufacture or uniform or regularly shaped fibers and hollow fibers, which fluctuate no more than 6% with respect to wall thickness and outer diameter. In various fields of application this is of particular benefit, for example with piezo ceramics and ceramic products which are to be used in high-vacuum.

The ceramic fibers, specifically the micro-hollow fibers, which are obtained according to the invention are suitable for use in a variety of application fields, for example for producing piezo-ceramics, implants, temperature-resistant conveyor belts, metal-ceramic composites or other compounds, reinforcements in the building industry, elements in electro-rheology, safety foils, gas-filled foils, carrier materials, non-burnable and non-decayable paper grades, the matrix of metal melts or of thin-walled polymer components, or of elements for refrigeration, for thermal insulation, for transport of light or for gasket-seals and panellings. The micro-hollow fiber is particularly suitable as reinforcement, in form of sapphire in a mullite matrix, but also in form of disks for power brakes.

The invention is explained in more detail below, making use of an example:

### EXAMPLE

In order to manufacture a ceramic micro-hollow fiber, a spinning device made by KWH HESCHO was used. By way of ceramic starter material, a ceramic mass from a ceramic melting process was employed which was obtained by melting a mixture of Al₂O₃ and alumo-silicates in powder form. The obtained paste-like melted mass was filled in to a charging vessel of the spinning device and pressed with a compactor, devoid of any bubbles, into the spinner head.

The transport temperature amounted to 2300° C. The pasty mass was extruded by more than 3000 ring-shaped nozzle apertures of the spinning head. The diameter of the nozzle apertures was 140 μm. By way of lumen maker for the formation of hollow fibers, co-axial baffle plates were used with a diameter of 80 μm. The obtained micro-hollow fibers had a wall thickness of approximately 5.5 μm and an outer diameter is approximately 33 μm. The micro-hollow fibers were reduced in their inner and outer diameter by means of stretching at plasticity temperature. The stretching took place at a temperature of 1600° C. After stretching, the hot micro fiber (temperature=1600° C.) was wound on coils and in doing so, cooled down to 640° C. by a mixture of air and gas, and thus crystallized and solidified. The off-take velocity was approximately 200 m/min. The stretched micro-hollow fibers had a wall thickness of approximately 0.9 μm and an outer diameter of approximately 6 μm.

We claim:

1. Method for the manufacture of ceramic fibers from liquefied material, characterized in that liquefied material of ceramic starter materials, having a temperature of at least 1150° C., are passed through the nozzle of a mold and subsequently permitted to solidify, wherein at least the components of the mold which are subjected to the influence of the melted material, consist of material having a melting point above approximately 2200° C., the necessary solidity and corrosion-resistance.

2. Method according to claim 1, characterized in that at least those components of the mold which are subjected to the influence of the melted material consist of tatalum, tungsten, materials of the eighth side-group of the periodic system, aluminum-nitride and/or zirconium-dioxide.

3. Method according to claim 1 or 2, characterized in that oxide, nitride and/or carbide ceramic starter materials are employed.

4. Method according to claims I to 3, characterized in that the liquefied material of the ceramic starter materials has a temperature of at least approximately 1600° C., specifically at least approximately 1900° C.

5. Method according to claim 3 or 4, characterized in that aluminum-oxide, magnesium-oxide, silicon-oxide, titanium-dioxide, beryllium-oxide and/or zirconium-oxide are used as ceramic starter material.

6. Method according to at least one of the preceding claims, characterized in that the nozzle of the mold for the manufacture of hollow fibers has a co-axial lumen maker.

7. Method according to claim 6, characterized in that micro-hollow fibers having a wall thickness of approximately 0.01 to 15 μm and an outer diameter if approximately 0.5 to 35 μm are produced by appropriate dimensioning of the nozzle.

8. Ceramic fibers, obtainable according to at least one of the preceding claims and characterized in that they are monolithic.

9. Ceramic fibers according to claim 8, characterized in that these are monolithic micro-fibers, specifically micro-hollow fibers.

10. Ceramic fibers according to claim 9, characterized in that these are monolithic micro-hollow fibers having a wall thickness of approximately 0.01 to 15 μm and an outer diameter of approximately 0.5 to 35 μm.

11. Ceramic fibers according to claim 9 or 10, characterized in that the fluctuation of wall thickness and outer diameter does not amount to more than 6%.

12. Utilization of the ceramic fibers, specifically micro-hollow fibers, according to at least one of the preceding claims for manufacturing piezo ceramics, implants, temperature-resistant conveyor belts, metal-ceramic composites or other composite materials, reinforcements for the building industry, elements in electro-rheology, safety foils, gas-filled foils, carrier materials, non-burnable and non-decayable paper grades, the matrix of metal melts or the matrix of thin-walled polymer components or elements of refrigeration, for thermal insulation, for the transport of light or for seals and panellings.
